(19) United States
(12) Patent Application Publication
(10) Pub. No.: US 2014/0165883 A1
(43) Pub. Date: Jun. 19, 2014

(54) LOAD SECURING SYSTEM

(71) Applicant: European Packaging Service GmbH, Monheim (DE)

(72) Inventor: Jeanette Staps, Monheim (DE)

(21) Appl. No.: 14/089,937

(22) Filed: Nov. 26, 2013

Related U.S. Application Data
(60) Provisional application No. 61/729,752, filed on Nov. 26, 2012.

(51) Int. Cl. B65D 19/44; B32B 29/00; B32B 3/12

(52) U.S. Cl. CPC B65D 19/44; B32B 3/12; B32B 29/005
USPC 108/55.1; 428/116

(57) ABSTRACT

The cargo loading and transport system, particularly for barrels for hazardous materials such as e.g. chemicals, comprises a carrier plate (38) provided to support cargo (40) for transportation, and angle-section bar elements (10) comprising cardboard material, for arrangement on upper outer edges (41) of the cargo (40) facing away from the carrier plate (38). The cargo loading and transport system further comprises lashing straps (44) to be strapped around the carrier plate (38), the angle-section bar elements (10) and the cargo (40) arranged therebetween.

The present invention relates to a cargo loading and transport system, particularly for barrels with hazardous materials such as e.g. chemicals.

The securing of cargo is of importance for prevention of accidents and injuries. Inadequate securing of cargo frequently causes the cargo to slip out of position during transport and or when handled by machinery, with the possible result of damage or even accidents with physical injuries.

Cargo securing systems are known in various configurations. One of these configurations is the form-locking cargo securement which is often realized by use of plastic materials for packaging (e.g. shrink film wrappings or foamed materials) which are not only expensive but also hardly environmentally friendly.

Another known variant of cargo securement is the force-locking cargo securement which is effected by tie-down lashing. Herein, the cargo is additionally pressed against the cargo floor e.g. with the aid of lashing straps, thus increasing the static friction so that the cargo is prevented from slipping. Normally, for protecting the cargo, panels are inserted between the cargo and lashing straps. In DE 20 2004 010 558 U1, a dimensionally stable panel assembly is described. WO 2009/010022 A1 describes a cargo loading and transportation securement system comprising mutually intersecting webs of cardboard material which will be laid onto the top side of to-be-fixed barrels and be strapped tight.

It is an object of the invention to provide a cargo loading and transport system which will enhance the safety in loading and transportation of cargo in a simple manner.

To achieve the above object, the invention proposes a cargo loading and transport system, particularly for barrels for hazardous materials such as e.g. chemicals, said system comprising
a carrier plate provided to support cargo for transportation,
angle-section bar elements comprising cardboard material, for arrangement on upper outer edges of the cargo facing away from the carrier plate, and
lashing straps to be strapped around the carrier plate, the angle-section bar elements and the cargo arranged therebetween.

The cargo loading and transport system according to the invention, provided particularly for hazardous material barrels containing chemicals, comprises, as one of its component parts, a carrier plate for support of the cargo that is to be transported. In the simplest case, said carrier plate is a pallet or the like. The system of the invention further comprises lashing straps for strapping down the cargo to the carrier plate. According to the invention, the cargo loading and transport system further comprises angle-section bar elements in the form of bars with angular cross section, which will be arranged along the upper outer edges of the cargo resting on the carrier plate, thus offering a kind of edge and anti-slip protection. Now, the lashing straps will be laid around said angle-section bar elements, be guided around the carrier plate and then be strapped tight. The inner sides of the angle-section bar elements preferably comprise an anti-slip coating or are provided with an anti-slip cover.

For enhancing the static friction between the cargo and the carrier plate, it is suitable to arrange an intermediate layer between the cargo and the carrier plate, while at least one of the two sides and preferably both sides of the intermediate layer should have an anti-slip coating thereon.

The angle-section bar element of the cargo loading and transport system of the invention is angular in cross section and comprises two interconnected legs extending at an angular orientation relative to each other. Advantageously, each of said legs comprises
at least one honeycomb layer made of cardboard material, said honeycomb layer comprising a plurality of mutually adjacent and substantially undulated honeycomb walls,
with respectively adjacent honeycomb walls being connected to each other and being arranged to form honeycombs between them, said honeycombs being open toward two mutually opposite major sides of the honeycomb layer,
an outer and an inner cover layer of cardboard material,
with said cover layers being arranged on the major sides of the honeycomb layer, and
an anti-slip coating arranged on at least one of the two cover layers.

The angle-section bar element of the system of the invention comprises at least one honeycomb layer extending at an angular configuration and made of cardboard material which can be e.g. recycled paper or cellulose paper of various thicknesses (e.g. cardboard, corrugated board). Said honeycomb layer comprises a plurality of mutually adjacent, substantially undulated honeycomb walls. For forming the honeycombs, respectively adjacent honeycomb walls are connected to each other, with the honeycombs being open toward two mutually opposite major sides of the honeycomb layer. For covering the honeycomb openings, an outer and an inner cover layer are arranged on them which form the outer side and the inner side of the angle-section bar element. The cover layers as well as the honeycomb layer are produced by use of cardboard material. In order to increase the static friction between the angle-section bar element of the invention and the cargo which is to be secured, one of the two cover layers is provided with an anti-slip coating. The anti-slip coating can be realized e.g. as a rubber coating or the like, which in products like cardboard (e.g. as anti-slip cardboard) is known per se and is already used in the packaging industry.

Advantageously, both cover layers can be coated on their outer sides for slip prevention. This anti-slip coating can be applied directly on the outer side of the cover layer. For instance, the anti-slip coating can be produced by applying anti-slip substances directly onto the outer side of the cover layer.

Further, it can be provided that the anti-slip coating is applied on a carrier layer of cardboard material fixed directly to the outer side of the cover layer. Also, a rubber film or anti-slip cardboard can be bonded e.g. directly to the outer side of the cover layer.

According to an advantageous embodiment of the invention, it is provided that the anti-slip coating is water-tight.

According to a further possible embodiment of the angle-section bar element, the lateral edges of the honeycomb layer are covered by protective layers. Preferably, the protective layers can be formed as extension flaps of the at least one cover layer, with the extension flaps laterally projecting from at least one of said carrier layers fixed to the outer side of the cover layer. For instance, the extension flaps can laterally project from both carrier layers fixed to the outer side of the cover layer. The extension flaps can be attached on the lateral edges by bonding. Thus, the honeycomb layer is closed on its edges, wherein the outer side and/or the inner side of the angle-section bar element can be fully coated for slip prevention and the honeycomb layer can be protected against humidity.

Preferably, for enhancing the stability of the angle-section bar element, a plurality of honeycomb layers can be arranged between the cover layers. The honeycomb layers can be arranged above each other in such a manner that the longitudinal direction of the honeycomb walls of a honeycomb layer is oriented transversely to the longitudinal direction of the honeycomb walls of an adjacent honeycomb layer. It is possible e.g. to arrange intermediate layers between respective adjacent honeycomb layers.

Preferably, a compliant layer of paper material (e.g. corrugated board) is arranged between at least one of the cover layers and the anti-slip coating. In this manner, the anti-slip coating can adapt to the shape of the cargo which is to be secured, resulting in a maximum contact area.

Production of the angle-section bar element can be suitably performed by kinking or bending of a (strip-shaped) plate element or panel which comprises at least one honeycomb layer having cover layers applied on both of its sides, with at least one anti-slip coating arranged on one of the two cover layers. In other words, the strip-shaped plate element and respectively panel is of the layered configuration which has been described above in the context of the angle-section bar element and respectively of the two legs of the angle-section bar element. In order to facilitate the kinking or bending, it is suitable if the strip-shaped plate element and respectively panel is formed with a V-shaped indentation or the like on at least one of its major sides, said indentation extending sufficiently deep into the plate element and respectively panel.

The invention further relates to a plate element for a cargo loading and transport system, particularly for hazardous materials such as e.g. chemicals. The invention further relates to a cargo loading and transport system provided with the plate element according to the invention.

The securing of cargo is of importance for prevention of accidents and injuries. Inadequate securing of cargo frequently causes the cargo to slip out of position during transport and or when handled by machinery, with the possible result of damage or even accidents with physical injuries.

Cargo securing systems are known in various configurations. One of these configurations is the form-locking cargo securement which is often realized by use of plastic materials for packaging (e.g. shrink film wrappings or foamed materials) which are not only expensive but also hardly environmentally friendly.

Another known variant of cargo securement is the force-locking cargo securement which is effected by tie-down lashing. Herein, the cargo is additionally pressed against the cargo floor e.g. with the aid of lashing straps, thus increasing the static friction so that the cargo is prevented from slipping. Normally, for protecting the cargo, panels are inserted between the cargo and lashing straps.

A further object of the invention thus resides in providing a plate element for a cargo loading and transport system that will enhance the safety in loading and transportation of cargo in a simple manner. Further, it is an object of the invention to provide a cargo loading and transport system which comprises such a plate element.

According to the invention, for achieving the above further object, there is proposed a plate element for a cargo loading and transport system, wherein said plate element comprises
at least one honeycomb layer made of paper material, said honeycomb layer comprising a plurality of mutually adjacent and substantially undulated honeycomb walls,
with respectively adjacent honeycomb walls being connected to each other and being arranged to form honeycombs between them, said honeycombs being open toward two mutually opposite major sides of the honeycomb layer,
an outer and an inner cover layer of paper material,
with said cover layers being arranged on the major sides of the honeycomb layer, and
an anti-slip coating arranged on at least one of the two cover layers.

The plate element according to the invention comprises at least one honey-comb layer made of paper material which can be e.g. recycled paper or cellulose paper of various thicknesses (e.g. cardboard, corrugated board). Said honeycomb layer comprises a plurality of mutually adjacent, substantially undulated honeycomb walls. For forming the honeycombs, respectively adjacent honeycomb walls are connected to each other, with the honeycombs being open toward two mutually opposite major sides of the honeycomb layer. For covering the honeycomb openings, an upper and a lower cover layer are arranged on the major sides of the honeycomb layer. The cover layers as well as the honeycomb layer are produced by use of paper material. In order to increase the static friction between the plate element of the invention and the cargo which is to be secured, one of the two cover layers is provided with an anti-slip coating. The anti-slip coating can be realized e.g. as a rubber coating or the like, which in products like paper (e.g. as anti-slip cardboard) is known per se and is already used in the packaging industry.

Advantageously, both cover layers can be coated on their outer sides for slip prevention. This anti-slip coating can be applied directly on the outer side of the cover layer. For instance, the anti-slip coating can be produced by applying anti-slip substances directly onto the outer side of the cover layer.

Further, it can be provided that the anti-slip coating is applied on a carrier layer of paper material fixed directly to the outer side of the cover layer. Also, a rubber film or anti-slip cardboard can be bonded e.g. directly to the outer side of the cover layer.

According to an advantageous embodiment of the invention, it is provided that the anti-slip coating is water-tight.

According to a further possible embodiment of the plate element according to the invention, the lateral edges of the honeycomb layer are covered by protective layers. Preferably, the protective layers can be formed as extension flaps of the at least one cover layer, with the extension flaps laterally projecting from at least one of said carrier layers fixed to the outer side of the cover layer. For instance, the extension flaps can laterally project from both carrier layers fixed to the outer side of the cover layer. The extension flaps can be attached on the lateral edges by bonding. Thus, the honeycomb layer of the plate element is closed on all sides, wherein the outer side of the plate element is fully coated for slip prevention and the honeycomb layer of the plate element is protected against humidity.

Preferably, for enhancing the load-bearing capacity of the plate element, a plurality of honeycomb layers can be arranged between the cover layers. The honeycomb layers can be arranged above each other in such a manner that the longitudinal direction of the honeycomb walls of a honeycomb layer is oriented transversely to the longitudinal direction of the honeycomb walls of an adjacent honeycomb layer. It is possible e.g. to arrange intermediate layers between respective adjacent honeycomb layers.

Preferably, a compliant layer of paper material (e.g. corrugated board) is arranged between at least one of the cover layers and the anti-slip coating. In this manner, the anti-slip coating can adapt to the shape of the cargo which is to be secured, resulting in a maximum contact area.

According to the invention, for achieving the above object, there is also proposed a cargo loading and transport system, particularly for hazardous materials such as e.g. chemicals, wherein said cargo loading and transport system is provided with
a palette for supporting the cargo,
a plate element according to the invention, adapted to be placed on the top side of the cargo facing away from the palette, and
lashing straps to be arranged under tension around the palette and the plate element with the cargo arranged therebetween.

The cargo loading and transport system according to the invention is provided with a palette (such as e.g. a wooden palette) on which the cargo to be secured will be placed. For increasing the static friction between the cargo and the palette, it is suitable to arrange an intermediate layer between the cargo and the palette, at least one of the two sides and preferably both sides of the intermediate layer being coated for slip prevention. For safety in loading and transportation of cargo, a plate element according to the invention will be placed by its anti-slip coated side onto the top side of the cargo facing away from the palette. Finally, the palette and the plate element with the cargo arranged therebetween will be fastened by at least two intersecting lashing straps.

The invention will be explained in greater detail hereunder by way of an exemplary embodiment and with reference to the drawing. In the several views of the drawing, the following is shown:

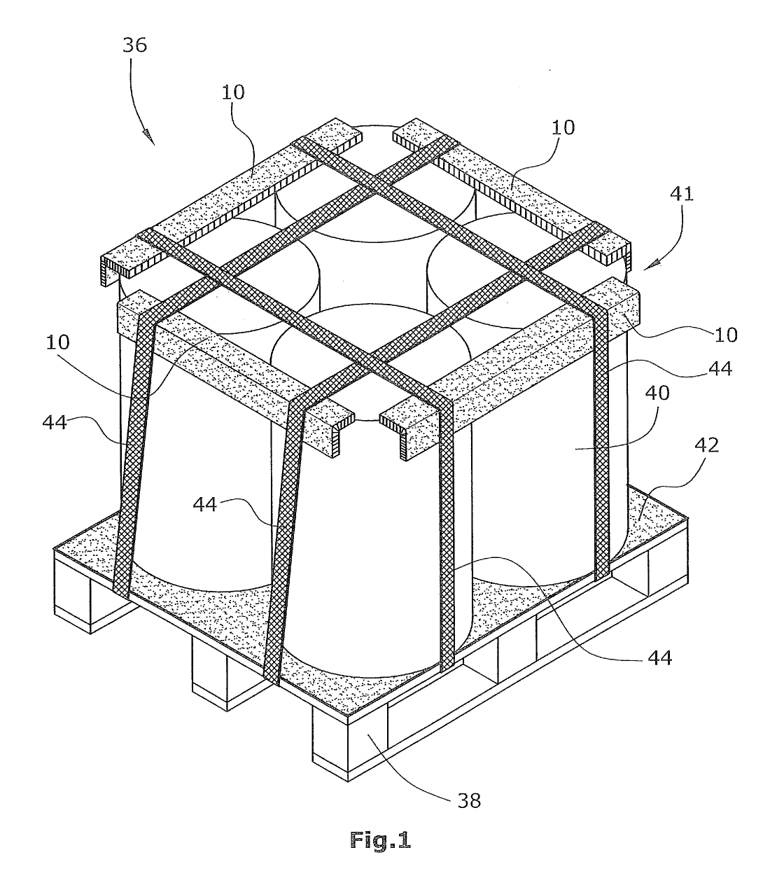

FIG. 1 is a perspective view of a cargo loading and transport system,

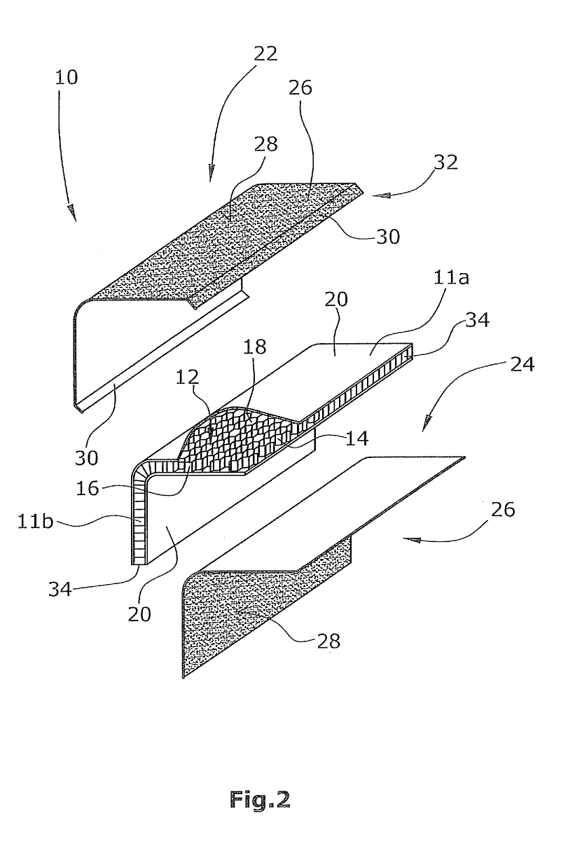

FIG. 2 is a perspective view of an angle-section bar element made of cardboard material and having a central honeycomb layer and cover layers covered for slip prevention, as adapted for use in the cargo loading and transport system according to FIG. 1,

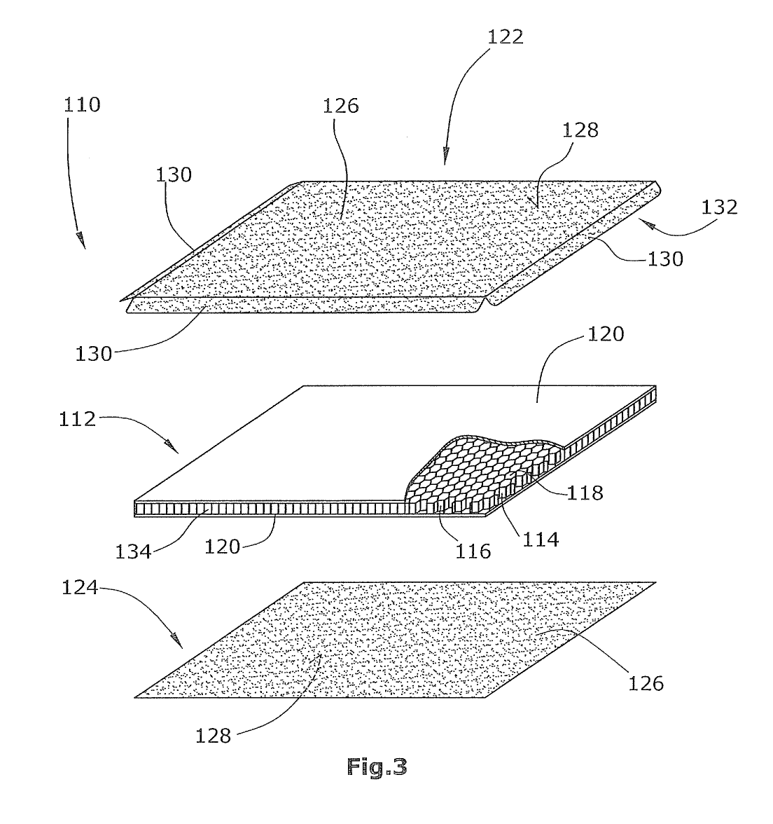

FIG. 3 is an exploded view of a plate element of a cargo loading and transport system,

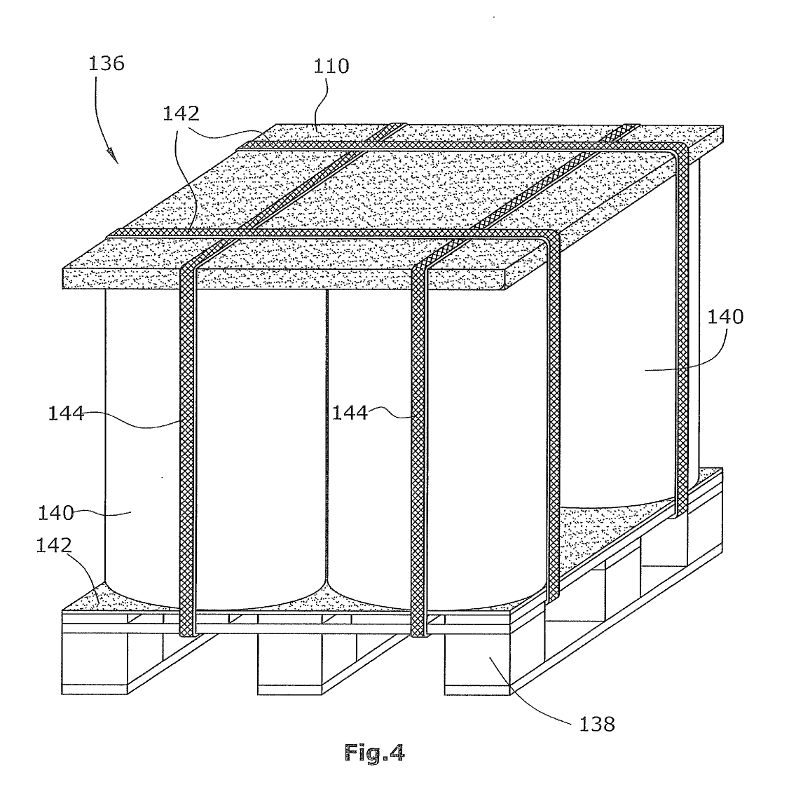

FIG. 4 is a perspective view of a cargo loading and transport system with the plate element and the cargo to be secured, and

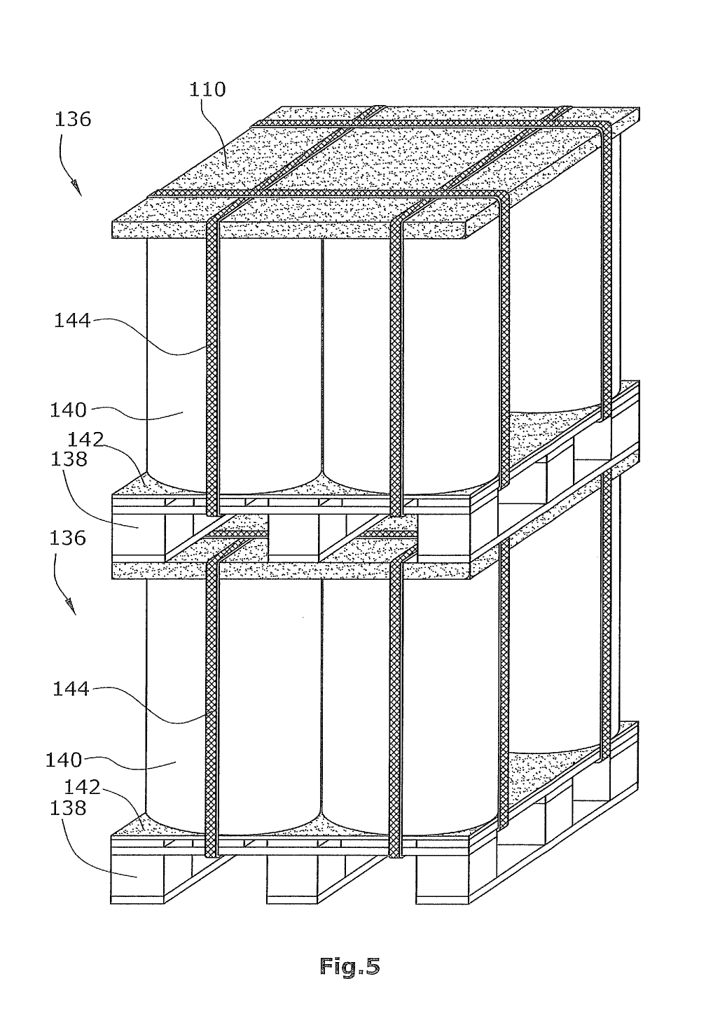

FIG. 5 is a perspective view of a cargo loading and transport system with a plurality of palettes stacked onto each other and with cargo secured on them.

FIG. 1 shows a perspective view of a cargo loading and transport system 36. The cargo loading and transport system 36 comprises e.g. a wooden palette as a carrier plate 38. The cargo 40 to be secured (e.g. barrels) will be deposited on the carrier plate 38. In order to increase the static friction between the cargo 40 and the carrier plate 38, an intermediate layer 42 coated for slip prevention can be arranged between them. The upper outer edges 41 of the cargo are abutted by angle-section bar elements 10 made of multi-layered cardboard material, said elements having at least their inner sides provided with an anti-slip coating (see FIG. 2 and subsequent description). With the aid of lashing straps 44, the carrier plates 38, the angle-section bar elements 10 and the cargo 40 arranged therebetween are strapped tight. The static friction between the cargo 40 and the angle-section bar elements 10 and between the lashing straps 44 and the angle-section bar elements 10 is increased by anti-slip cardboard portions on the inner and outer sides of the angle-section bar elements 10 so that the cargo is secured from slipping when being handled or transported.

As shown in FIG. 2, the angle-section bar element 10 comprises two legs 11a,11b and a honeycomb layer 12 made of cardboard. The honeycomb layer 12 comprises a plurality of substantially undulated honeycomb walls 14. For forming the honeycombs 16, the honeycomb walls 14 are arranged adjacent to each other, wherein respectively adjacent honeycomb walls 14 are connected to each other. A plurality of such honeycombs 16 form a rectangular honeycomb layer 12 having two opposite major sides. Each honeycomb 16 is open toward the two mutually opposite major sides. For covering the openings 18 of the honeycombs 16, the two major sides of the honeycomb layer 12 are covered by an outer upper and an inner lower cover layer 20 of cardboard. The cover layers 20 can be fastened e.g. by bonding on the major sides of the honeycomb layer 12.

FIG. 2 further shows two carrier layers 26 which are realized e.g. as anti-slip cardboard portions 22 and 24 and are provided with an anti-slip coating 28 which in the present embodiment is water-tight, said carrier layers being fixed on the outer and respectively inner cover layer 20 (e.g. by bonding). These cover layers 20 form the outer side and the inner side of the angle-section bar element. The surface area of the anti-slip cardboard portion 24 fixed to the lower cover layer 20 is as large as the surface area of the lower cover layer 20. The other rectangular anti-slip cardboard portion 22 is on each side provided with a projecting extension flap 30. The two extension flaps 30 of the anti-slip cardboard portion 22 can be bent for forming protective layers 32, so that two lateral edges 34 of the honeycomb layer 12 are covered and thus are protected from intrusion of liquids. Attachment of the two anti-slip cardboard portions 22 and 24 on the cover layers 20 and of the extension flaps 30 on the lateral edges 34 can be performed e.g. by bonding. Thus, the honeycomb layer 12 of the angle-section bar element 10 is closed on all sides, while its outer and inner sides are fully coated for slip prevention. Alternatively, the extension flaps 30 can come to abut on the lateral edges 34 of the honeycomb layer 12 (without being bonded) only at the time when, as shown in FIG. 1, the angle-section bar element 10 has been inserted in the suitable manner.

As shown in FIG. 3, the plate element 100 comprises a honeycomb layer 120 made of cardboard. The honeycomb layer 120 comprises a plurality of substantially undulated honeycomb walls 140. For forming the honeycombs 160, the honeycomb walls 140 are arranged adjacent to each other, wherein respectively adjacent honeycomb walls 140 are connected to each other. A plurality of such honeycombs 160 form a rectangular honeycomb layer 120 having two opposite major sides. Each honeycomb 160 is open toward the two mutually opposite major sides. For covering the openings 180 of the honeycombs 160, the two major sides of the honeycomb layer 120 are covered by an upper and a lower cover layer 200 of cardboard. The cover layers 200 can be fastened e.g. by bonding on the major sides of the honeycomb layer 120.

FIG. 3 further shows two carrier layers 260 which are realized e.g. as anti-slip cardboard portions 220 and 240 and are provided with an anti-slip coating 280 which in the present embodiment is water-tight, said carrier layers 260 being fixed on the outer and respectively inner cover layer 200 (e.g. by bonding). The surface area of the anti-slip cardboard portion 240 fixed to the lower cover layer 200 is as large as the surface area of the lower cover layer 200. The other rectangular anti-slip cardboard portion 220 is on each side provided with a projecting extension flap 300. The four extension flaps 300 of the anti-slip cardboard portion 220 can be bent for forming protective layers 320, so that lateral edges 340 of the honeycomb layer 120 are covered and thus are protected from intrusion of liquids. Attachment of the two anti-slip cardboard portions 220 and 240 on the cover layers 200 and of the extension flaps 300 on the lateral edges 340 can be performed e.g. by bonding. Thus, the honeycomb layer 120 of the plate element 100 is closed on all sides, while its outer side is fully coated for slip prevention. Alternatively, the extension flaps 300 can come to abut on the lateral edges 340 of the honeycomb layer 120 (without being bonded) only at the time when, as shown in FIG. 4, the plate element 100 has been inserted in the suitable manner.

FIG. 4 shows a perspective view of a cargo loading and transport system 360. The cargo loading and transport system 360 comprises e.g. a wooden palette 380. The cargo 400 to be secured (e.g. barrels) will be deposited on the wooden palette 380. In order to increase the static friction between the cargo 400 and the palette 380, an intermediate layer 420 coated for slip prevention can be arranged between them. The plate element 100 of the invention will be deposited on the top side of the cargo 400 facing away from the wooden palette 380. With the aid of lashing straps 440, the carrier plates 380, the plate element 100 and the cargo 400 arranged therebetween are strapped tight. The static friction between the cargo 400 and the plate element 100 and between the lashing straps 440 and the plate element 100 is increased by the anti-slip cardboard portions 220,240 so that the cargo 400 is secured from slipping when the cargo 400 are handled or transported.

A plurality of palettes 380 of the cargo loading and transport system 360 together with the cargo 400 secured by them can be stacked on top of each other. In FIG. 5, for instance, there are shown two palettes 380, stacked on top of each other, with the cargo 400 secured by them. In such a configuration, the top sides of the plate elements 100 should be coated for slip prevention. Thereby, the static friction between the top side of the plate element 100 and the bottom side of the wooden palette 380 resting thereon is increased, so that the stacked palettes 380 with the cargo 400 are secured against slipping.

### LIST OF REFERENCE NUMERALS

10 angle-section bar element
12 honeycomb layer
14 honeycomb wall of honeycomb layer
16 honeycomb of honeycomb layer
18 honeycomb opening
20 cover layer
22 outer anti-slip cardboard portion
24 inner anti-slip cardboard portion
26 carrier layer
28 anti-slip coating
30 extension flap
32 protective layer
34 lateral edges of honeycomb layer
36 cargo loading and transport system
38 carrier plate
40 cargo
41 upper outer edge of cargo
42 intermediate layer
44 lashing straps
100 plate element
120 honeycomb layer
140 honeycomb wall of honeycomb layer
160 honeycomb of honeycomb layer
180 honeycomb opening
200 cover layer
220 upper anti-slip cardboard portion
240 lower anti-slip cardboard portion
260 carrier layer
280 anti-slip coating
300 extension flap
320 protective layer
340 lateral edges of honeycomb layer
360 cargo loading and transport system
380 palette
400 cargo
420 intermediate layer
440 lashing straps

1. A cargo loading and transport system, particularly for barrels for hazardous materials such as e.g. chemicals, said system comprising
a carrier plate provided to support cargo for transportation,
angle-section bar elements comprising cardboard material, for arrangement on upper outer edges of the cargo facing away from the carrier plate, and
lashing straps to be strapped around the carrier plate, the angle-section bar elements and the cargo arranged therebetween.

2. The cargo loading and transport system of claim 1, wherein the angle-section bar elements, when viewed in cross section, comprise interconnected legs extending at an angle relative to each other, and that each leg comprises
at least one honeycomb layer made of cardboard material, said honeycomb layer comprising a plurality of mutually adjacent and substantially undulated honeycomb walls,
with respectively adjacent honeycomb walls being connected to each other and being arranged to form honeycombs between them, said honeycombs being open toward two mutually opposite major sides of the honeycomb layer,
an outer and an inner cover layer of cardboard material,
with said cover layers being arranged on the major sides of the honeycomb layer, and
an anti-slip coating arranged on at least one of the two cover layers.

3. The cargo loading and transport system of claim 2, wherein each cover layer is coated on its outer side for slip prevention.

4. The cargo loading and transport system of claim 1, wherein the anti-slip coating is applied directly on the outer side of the cover layer or the anti-slip coating is applied on a carrier layer of cardboard material fixed to the outer side of at least one of the cover layers.

5. The cargo loading and transport system of claim 2, wherein the lateral edges of the honeycomb layer can be covered by protective layers, the protective layers being formed as extension flaps of the at least one of the cover layers.

6. The cargo loading and transport system of claim 4 wherein the extension flaps laterally project from at least one of said carrier layers.

7. The cargo loading and transport system of claim 2, wherein one or a plurality of honeycomb layers are arranged between the cover layers.

8. The cargo loading and transport system of claim 2, wherein a compliant layer of card board material is arranged between at least one of the cover layers and the anti-slip coating.

9. The cargo loading and transport system of claim 1, wherein the angle-section bar elements are produced by kinking or bending a plate with layered structure of the legs of an angle-section bar element, said kinking or bending being facilitated by a groove formed in at least one side of the plate, and said groove extending at least into the medium depth of the thickness of the honeycomb layer.

10. The cargo loading and transport system of claim 1, wherein, for increasing the static friction, an intermediate layer particularly of cardboard material is arranged between the cargo and the carrier plate, at least one of the two sides of the intermediate layer having an anti-slip coating thereon.

11. A plate element for a cargo loading and transport system, said plate element comprising
at least one honeycomb layer made of paper material, said honeycomb layer comprising a plurality of mutually adjacent and substantially undulated honeycomb walls,
with respectively adjacent honeycomb walls being connected to each other and being arranged to form honeycombs between them, said honeycombs being open toward two mutually opposite major sides of the honeycomb layer,
an outer and an inner cover layer of paper material,
with said cover layers being arranged on the major sides of the honeycomb layer, and
an anti-slip coating arranged on at least one of the two cover layers.

12. The plate element of claim 11, wherein each cover layer is coated for slip prevention on its outer side.

13. The plate element of claim 11, wherein the anti-slip coating is applied directly on the outer side of the cover layer.

14. The plate element of any one of claims 11, wherein the anti-slip coating is applied on a carrier layer of paper material fixed to the outer side of at least one of the cover layers.

15. The plate element of claim 11, wherein the lateral edges of the honeycomb layer can be covered by protective layers.

16. The plate element claim 11, wherein the protective layers are formed as extension flaps of the at least one cover layer.

17. The plate element of claim 14 wherein the extension flaps laterally project from at least one of said carrier layers.

18. The plate element of claim 11, wherein one or a plurality of honeycomb layers are arranged between the cover layers.

19. The plate element of claim 11, wherein a compliant layer of paper material is arranged between at least one of the cover layers and the anti-slip coating.

20. A cargo loading and transport system, particularly for hazardous materials such as e.g. chemicals, said cargo loading and transport system comprising
a palette for supporting the cargo,
a plate element according to claim 1, adapted to be placed on the top side of the cargo facing away from the palette, and
lashing straps to be arranged under tension around the palette and the plate element with the cargo arranged therebetween.

21. The cargo loading and transport system of claim 20, wherein, for increasing the static friction, an intermediate layer is arranged between the cargo and the palette, at least one of the two sides of the intermediate layer having an anti-slip coating thereon.
